(19) United States
(12) Patent Application Publication
(10) Pub. No.: US 2012/0036349 A1
(43) Pub. Date: Feb. 9, 2012

(54) DATEBASE SERVER, CUSTOMER TERMINAL AND PROTECTION METHOD FOR DIGITAL CONTENTS

(75) Inventors: ZHAO-PING ZHANG, Shenzhen City (CN); HUA-DONG CHENG, Shenzhen City (CN); CHIH-SAN CHIANG, Tu-Cheng (TW); HAN-CHE WANG, Tu-Cheng (TW)

(73) Assignees: HON HAI PRECISION INDUSTRY CO., LTD., Tu-Cheng (TW); HONG FU JIN PRECISION INDUSTRY(ShenZhen) CO., LTD., Shenzhen City (CN)

(21) Appl. No.: 12/966,998

(22) Filed: Dec. 13, 2010

(30) Foreign Application Priority Data
Aug. 3, 2010 (CN) 201010243709.6

(51) Int. Cl. H04L 9/06

(52) U.S. Cl. 713/150

(57) ABSTRACT

A customer terminal is provided. The customer terminal includes a receiving module and a decryption module. The receiving module receives an encrypted digital content from a database server connected thereto. A predetermined encryption key encrypts the encrypted digital content. The decryption module decrypts the encrypted digital content utilizing hardware information from the customer terminal. A database server and a protection method are also provided to prevent an unauthorized customer terminal from copying digital contents.

### BACKGROUND

1. Technical Field

The present disclosure relates to copyright security, particularly, to a database server, a customer terminal and a protection method for digital contents.

2. Description of Related Art

For the protection of digital contents, encryption of the digital contents by an encryption algorithm before publishing on the internet is often used. A customer terminal cannot use the digital content unless the customer terminal owns a key corresponding to the encryption algorithm for encrypting the digital content. However, since the key is often not terminal-specific, once the key is obtained, it is easy to copy the key by other customer terminals, which allows an unauthorized customer terminal to use the digital content.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a block diagram of a protection system for digital contents, according to an exemplary embodiment.

FIG. 2 is a flowchart of downloading a digital content implemented by the protection system for digital contents of FIG. 1, according to an exemplary embodiment.

FIG. 3 is a flowchart of decrypting the digital content of FIG. 2.

### DETAILED DESCRIPTION

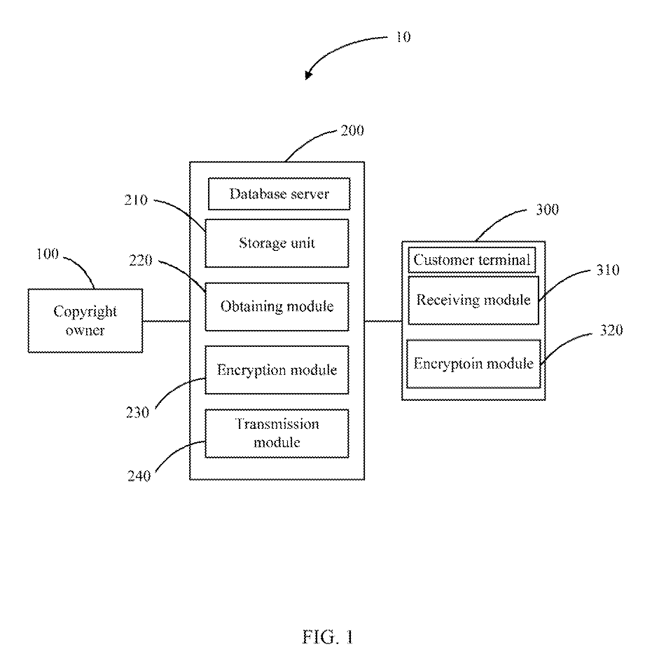

Referring to FIG. 1, a protection system for digital contents 10 according to an exemplary embodiment includes a copyright owner 100, a database server 200, and a customer terminal 300.

The copyright owner 100 provides digital content to the database server 200.

The customer terminal 300 is connected to the database server 200. The customer terminal 300 sends a request to the database server 200 for downloading the digital content through the network (not shown).

The database server 200 includes a storage unit 210, an obtaining module 220, an encryption module 230, and a transmission module 240. The storage unit 210 stores digital contents. The obtaining module 220 is used for obtaining hardware information of the customer terminal 300, for example, such as motherboard identification or hard disk identification, in response to the request from the customer terminal 300. The encryption module 230 is used for encrypting the digital content utilizing the hardware information. The transmission module 240 is used for transmitting the encrypted digital content to the customer terminal 300 through the network.

The customer terminal 300 includes a receiving module 310 and a decryption module 320. The receiving module 310 is used for receiving the encrypted digital content from the database server 200 or other customer terminal 300. The decryption module 320 is used for decrypting the encrypted digital content utilizing the hardware information of the customer terminal 300. If the hardware information of the customer terminal 300 matches the hardware information of the encrypted digital content, the decryption module 320 decrypts the encrypted digital content successfully and the customer terminal 300 uses the digital content freely. If the hardware information of the customer terminal 300 does not match the hardware information of the encrypted digital content, the decryption module 320 unsuccessfully decrypts the encrypted digital content, and the customer terminal 300 is forbidden to use the digital content. By utilizing the present disclosure, if another customer terminal copies the digital content from the customer terminal 300, because the hardware information of the other customer terminal does not match the hardware information of the encrypted digital content. The encrypted digital content cannot be decrypted successfully and the other customer terminal cannot use the digital content, thereby protecting the copyright of the digital content.

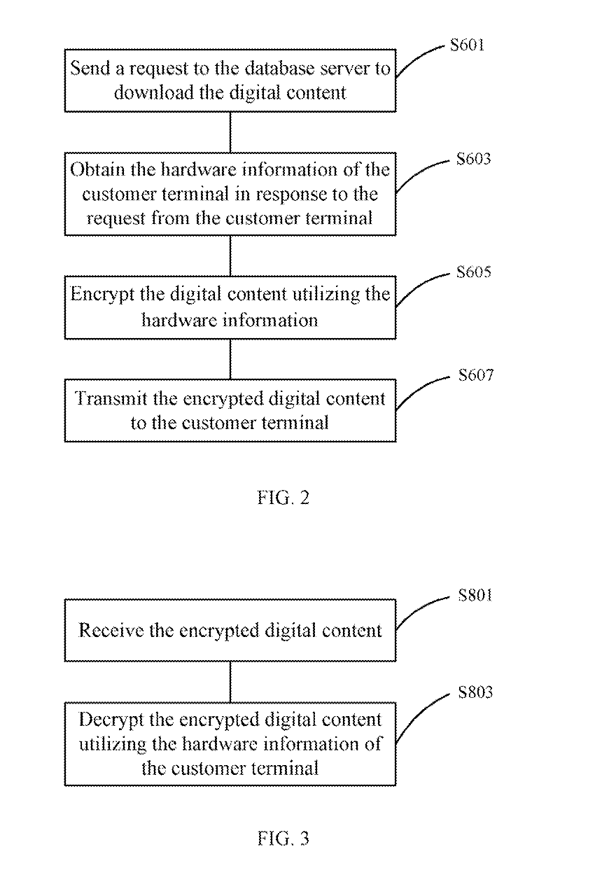

Referring to FIG. 2, a flowchart of downloading a digital content is provided.

In step S601, the customer terminal 300 sends a request to the database server 200 to download the digital content through the network.

In step S603, the obtaining module 220 obtains the hardware information of the customer terminal 300 in response to the request from the customer terminal 300.

In step S605, the encryption module 230 encrypts the digital content utilizing the hardware information obtained from the customer terminal 300.

In step S607, the transmission module 240 transmits the encrypted digital content to the customer terminal 300 through the network.

Referring to FIG. 3, a flowchart of decrypting the digital content is provided.

In step S801, the receiving module 310 receives the encrypted digital content encrypted by the hardware information of the customer terminal 300.

In step S803, the decryption module 320 decrypts the encrypted digital content utilizing the hardware information of the customer terminal 300. If the hardware information of the encrypted digital content matches the hardware information of the customer terminal 300, the decryption module 320 decrypts the encrypted digital content successfully and the customer terminal 300 can freely use the digital content. If the hardware information of the encrypted digital content does not match the hardware information of the customer terminal 300, the decryption module 320 decrypts the encrypted digital content unsuccessfully, and the customer terminal 300 is forbidden to use the digital content.

It is to be understood, however, that even though numerous characteristics and advantages of the present disclosure have been set fourth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. A database server applied in protecting digital contents, the database server connected to one or more customer terminals through a network, the database server comprising:
a storage unit configured for storing digital contents;
an obtaining module configured for obtaining hardware information of a customer terminal in response to a request from the customer terminal for downloading a digital content;
an encryption module configured for encrypting the digital content utilizing the hardware information; and
a transmission module configured for transmitting the encrypted digital content to the customer terminal

2. The database service as described in claim 1, wherein the hardware information of the customer terminal is selected from a group consisting of motherboard identification of the customer terminal and hard disk identification of the customer terminal

3. A customer terminal comprising:
a receiving module configured for receiving an encrypted digital content from a database server connected thereto, wherein the encrypted digital content is encrypted by a predetermined encryption key; and
a decryption module configured for decrypting the encrypted digital content utilizing a hardware information of the customer terminal

4. The customer terminal as described in claim 3, wherein the predetermined encryption key is a hardware information of the customer terminal which downloads the encrypted digital content.

5. The customer terminal as described in claim 4, wherein the hardware information is selected from a group consisting of motherboard identification and hard disk identification.

6. A protection method for digital contents, comprising:
obtaining a hardware information of a customer terminal which sends a request for a digital content;
encrypting the digital content utilizing the hardware information of the customer terminal; and
transmitting the encrypted digital content to the customer terminal;

7. The protection method for digital contents as described in claim 6, wherein the hardware information is selected from a group consisting of motherboard identification and hard disk identification.
